(19) United States
(12) Patent Application Publication
(10) Pub. No.: US 2012/0313979 A1
(43) Pub. Date: Dec. 13, 2012

(54) ILLUMINATION APPARATUS, METHOD FOR CONTROLLING THE SAME, AND LIQUID CRYSTAL DISPLAY APPARATUS

(75) Inventor: Yasuhiro Matsuura, Yokohama-shi (JP)

(73) Assignee: CANON KABUSHIKI KAISHA, Tokyo (JP)

(21) Appl. No.: 13/489,166

(22) Filed: Jun. 5, 2012

(30) Foreign Application Priority Data
Jun. 10, 2011 (JP) 2011-130410
Mar. 27, 2012 (JP) 2012-071494

(51) Int. Cl. G09G 3/36; G09G 5/10; H05B 37/02

(52) U.S. Cl. 345/690; 315/297; 315/152; 345/102

(57) ABSTRACT

An illumination apparatus comprises a light source unit having a first light source which is composed of a plurality of light-emitting elements for generating white light by color mixture and a second light source which is composed of a light-emitting element having a color different from those of the light-emitting elements for constructing the first light source and which generates white light by color mixture with the first light source; a judging unit which judges degrees of deterioration of the first and second light source; and a control unit which allows the first light source to emit light if the degree of deterioration of the first light source is smaller than that of the second light source and which allows the first and second light source to emit light if the degree of deterioration of the first light source is not less than that of the second light source.

### BACKGROUND OF THE INVENTION

1. Field of the Invention

The present invention relates to an illumination apparatus, a method for controlling the same, and a liquid crystal display apparatus.

2. Description of the Related Art

In order to perform the display with a desired color temperature by using a liquid crystal display apparatus, a method is known, in which a backlight is constructed by only a white light source, and the color temperature is adjusted by means of the image signal processing. Another method is known, in which a backlight is constructed by a primary color light source composed of light sources of a plurality of colors such as red, green, blue and the like, the light sources of the plurality of colors are turned ON (lighted) at an appropriate luminance ratio, and a target color temperature is realized by means of the additive color mixture. In relation to the methods as described above, the backlight, which is constructed by only the white light source, is excellent in the light emission efficiency, but the display color gamut is hardly widened. On the other hand, the backlight, which is constructed by the primary color light source composed of the light sources of the plurality of colors, makes it possible to widen the display color gamut, but it is difficult to realize the low electric power consumption, because the light emission efficiencies of the light sources of the respective colors are low. In view of the above, a system is conceived as follows. That is, a backlight is constructed by a white light source and a primary color light source composed of light sources of a plurality of colors, and the white light source and the primary color light source are turned ON while regulating the luminance ratio therebetween depending on a target color temperature so that both of the wide color gamut and the high efficiency are fulfilled thereby.

For example, Japanese Patent Application Laid-open No. 2010-128072 discloses a backlight apparatus in which a white light source and primary color light sources are subjected to the lighting driving control, wherein a light source or light sources is/are selected from the primary color light sources depending on a target color, and the white light source and the selected light source or light sources are turned ON (lighted) and driven depending on the target color.

Japanese Patent Application Laid-open No. 2010-528432 (PCT) discloses a backlight apparatus which has a plurality of color light sources and a number n of white light sources. In this case, the number n of the white light sources is selected so that the light emission efficiency in an output illumination range is raised or maximized while maintaining the color gamut of the backlight output at a predetermined ratio of a desired color gamut specification, for example, within 10%.

### SUMMARY OF THE INVENTION

In the case of Japanese Patent Application Laid-open No. 2010-128072, the light source is selected depending on the target color. However, if the backlight apparatus is used for a long period of time in a state in which the target color is fixed, any dispersion arises in the degree of deterioration between the light source which is used for the long period of time and the light source which is not used. Therefore, there is such a possibility that all of the light sources cannot be turned ON at desired luminances.

In the case of Japanese Patent Application Laid-open No. 2010-528432 (PCT), the number n of the white light sources is determined while maintaining the desired display color gamut. However, the aging deterioration of the luminance of the light source is not considered. A problem arises such that the service life of the backlight depends on the luminance deterioration speed of the light source which is turned ON at a high luminance.

In view of the above, the present invention provides a technique which suppresses degrees of deterioration of respective light sources from being nonuniform in an illumination apparatus having the plurality of light sources.

According to a first aspect of the present invention, there is provided an illumination apparatus comprising alight source unit having a first light source which is composed of a plurality of light-emitting elements for generating white light by means of color mixture and a second light source which is composed of a light-emitting element having a color different from those of the plurality of light-emitting elements for constructing the first light source and which generates white light by means of color mixture with the first light source; a judging unit which judges degrees of deterioration of the first light source and the second light source; and a control unit which allows the first light source to emit light if the degree of deterioration of the first light source is smaller than the degree of deterioration of the second light source and which allows the first light source and the second light source to emit light if the degree of deterioration of the first light source is not less than the degree of deterioration of the second light source.

According to a second aspect of the present invention, there is provided a method for controlling an illumination apparatus comprising a first light source which is composed of a plurality of light-emitting elements for generating white light by means of color mixture and a second light source which is composed of a light-emitting element having a color different from those of the plurality of light-emitting elements for constructing the first light source and which generates white light by means of color mixture with the first light source; the method comprising a judging step of judging degrees of deterioration of the first light source and the second light source, and a control step of allowing the first light source to emit light if the degree of deterioration of the first light source is smaller than the degree of deterioration of the second light source and allowing the first light source and the second light source to emit light if the degree of deterioration of the first light source is not less than the degree of deterioration of the second light source.

According to the present invention, it is possible to suppress the degrees of deterioration of the respective light sources from being nonuniform in the illumination apparatus having the plurality of light sources.

Further features of the present invention will become apparent from the following description of exemplary embodiments with reference to the attached drawings.

### BRIEF DESCRIPTION OF THE DRAWINGS

FIG. 1 shows a block diagram illustrating a schematic arrangement of a liquid crystal display apparatus according to a first embodiment.

FIG. 2A shows a flow chart illustrating the light source control for a backlight according to the first embodiment.

FIG. 2B shows a flow chart illustrating the light source control for the backlight according to the first embodiment.

FIG. 3 shows a flow chart illustrating the light source control for a backlight according to a second embodiment.

FIG. 4 shows a block diagram illustrating a schematic arrangement of a liquid crystal display apparatus according to a third embodiment.

FIG. 5 shows a flow chart illustrating the light source control for a backlight according to the third embodiment.

FIG. 6 shows a block diagram illustrating a schematic arrangement of a liquid crystal display apparatus according to a fourth embodiment.

FIG. 7 shows a flow chart illustrating the light source control for a backlight according to the fourth embodiment.

FIG. 8 shows a flow chart illustrating the light source control for a backlight according to the fifth embodiment.

FIG. 9 shows a flow chart illustrating the light source control for a backlight according to the sixth embodiment.

### DESCRIPTION OF THE EMBODIMENTS

### First Embodiment

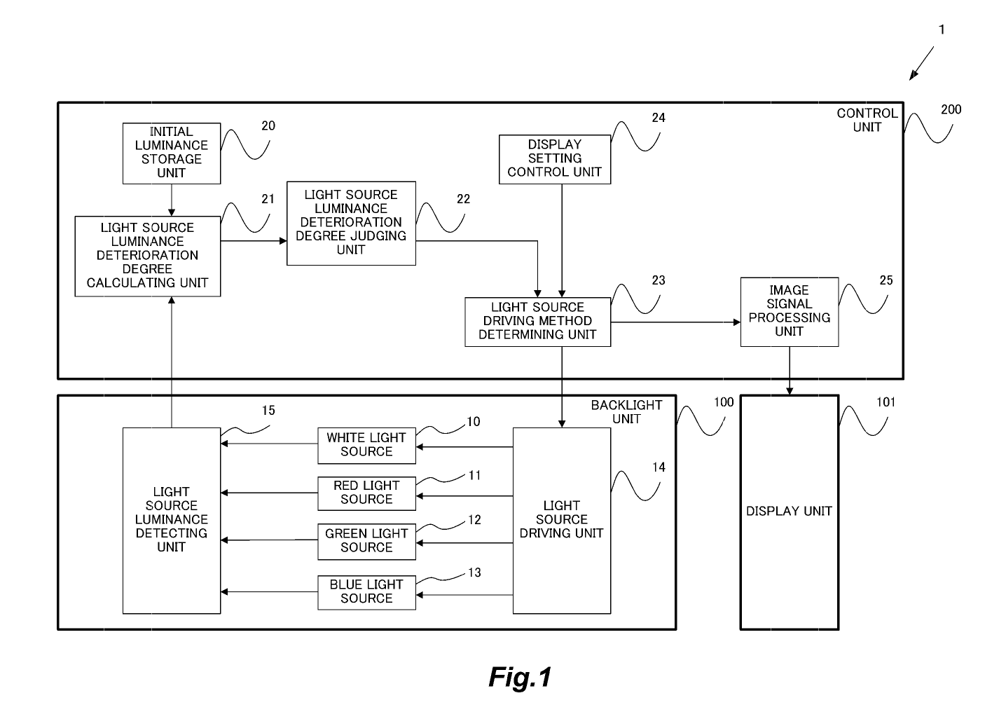

FIG. 1 shows a schematic arrangement of a liquid crystal display apparatus according to a first embodiment of the present invention. With reference to FIG. 1, the liquid crystal display apparatus 1 is composed of a backlight unit 100, a display unit 101, and a control unit 200. In the following description, a backlight apparatus, which is used for the liquid crystal display apparatus, is exemplified as the illumination apparatus by way of example. However, the present invention is not limited thereto. The present invention is applicable to any illumination apparatus provided that the illumination apparatus has a plurality of light sources and the white light is generated by means of the color mixture. The liquid crystal display apparatus is exemplified as the display apparatus, and the LED light-emitting element is exemplified as the light source of the backlight apparatus by way of example. However, it is possible to use various display panels and light source elements including, for example, organic EL based on the color filter system (system in which an organic EL light-emitting element and a color filter are used).

The backlight unit 100 is composed of a light source unit which includes a white light source 10, a red light source 11, a green light source 12, and a blue light source 13, a light source driving unit 14, and a light source luminance detecting unit 15. In this embodiment, the red light source 11, the green light source 12, and the blue light source 13 are collectively referred to as “primary color light source”. The primary color light source is the first light source (light source group) which generates the white light by means of the color mixture. The white light source 10 is the light source which has the color different from those of the red light source 11, the green light source 12, and the blue light source 13 for constructing the first light source. The white light source 10 is the second light source which generates the white light by means of the color mixture with the first light source.

The display unit 101 is a liquid crystal panel which displays an image based on an image signal by transmitting the illumination light emitted from the backlight unit 100 at a transmittance for each of pixels depending on the image signal to be inputted.

The control unit 200 is composed of an initial luminance storage unit 20, a light source luminance deterioration degree calculating unit 21, a light source luminance deterioration degree judging unit 22, a light source driving method determining unit 23, a display setting control unit 24, and image signal processing unit 25.

Each of the white light source 10, the red light source 11, the green light source 12, and the blue light source 13 is constructed by a device (light-emitting element) such as LED or the like for emitting the light. As for the arrangement of each of the light sources, one individual or a plurality of individuals may be connected in series or in parallel. The numbers of the respective light sources may be different from each other. For example, the number of green light sources may be twice the number of light sources of the other color. The numbers of the respective light sources are determined depending on the luminance specification and the color gamut specification of the liquid crystal display apparatus 1.

The light source driving unit 14 is constructed to include a current adjusting circuit and a voltage adjusting circuit for driving each of the light sources of the white light source 10, the red light source 11, the green light source 12, and the blue light source 13. The current adjusting circuit adjusts the current amount allowed to flow to each of the light sources depending on the current amount determined by the light source driving method determining unit 23 as described later on. When the light source is LED, the voltage adjusting circuit adjusts the output voltage in accordance with the forward direction voltage drop of LED which fluctuates depending on the driving current of each LED. It is assumed that the output voltage also fluctuates depending on the number of LEDs connected in series. In the case of any light source other than LED, it is assumed that the light source driving unit 14 generates the current and the voltage required when each of the light sources is turned ON (lighted) at a desired luminance.

The light source luminance detecting unit 15 detects the intensities of lights emitted from the respective light sources of the white light source 10, the red light source 11, the green light source 12, and the blue light source 13, i.e., the luminances of the light sources. The photodetection element, which constitutes the light source luminance detecting unit 15, may be capable of simultaneously detecting the luminances of the light sources having a plurality of different wavelengths, or the photodetection element may be capable of detecting the luminance of the light source having a single wavelength. When the light source luminance detecting unit 15 is constructed so that the luminance of the light source having the single wavelength can be detected, the light source luminance detecting unit 15 detects the luminances of the light sources having a plurality of different wavelengths by successively turning ON the respective light sources and successively detecting the luminance when each of the light sources is turned ON.

Next, the control unit 200 will be explained.

The initial luminance storage unit 20 stores, as the initial luminance, the luminance detected by the light source luminance detecting unit 15 when each of the light sources is turned ON with a predetermined current value and a pulse width (voltage modulation), for example, in a step after the production of the backlight apparatus. In this arrangement, the initial luminance storage unit 20 is constructed by a storage device such as RAM or the like.

The light source luminance deterioration degree calculating unit 21 calculates the luminance deterioration degree which indicates the degree of deterioration of the luminance of each of the light sources, on the basis of the comparison between the luminance of each of the light sources detected by the light source luminance detecting unit 15 and the luminance of each of the light sources stored in the initial luminance storage unit 20. The luminance deterioration degree of each of the light sources is the ratio between the luminance of each of the light sources detected by the light source luminance detecting unit 15 and the luminance of each of the light sources stored in the initial luminance storage unit 20, which is calculated in accordance with each of the following expressions.

White light source luminance deterioration degree W_{dgr}={(initial luminance of white light source)−(present luminance of white light source)}/(initial luminance of white light source)

Red light source luminance deterioration degree R_{dgr}={(initial luminance of red light source)−(present luminance of red light source)}/(initial luminance of red light source)

Green light source luminance deterioration degree G_{dgr}={(initial luminance of green light source)−(present luminance of green light source)}/(initial luminance of green light source)

Blue light source luminance deterioration degree B_{dgr}={(initial luminance of blue light source)−(present luminance of blue light source)}/(initial luminance of blue light source)

Further, the light source luminance deterioration degree calculating unit 21 calculates the primary color light source average luminance deterioration degree which is the average value of the luminance deterioration degrees of the primary color light sources (red light source, green light source, and blue light source), in accordance with the following expression.

Primary color light source average luminance deterioration degree RGB_{dgrAV}=(R_{dgr}+G_{dgr}+B_{dgr})/3

The numerical value of the denominator herein represents the number of colors for constructing the primary color light sources.

The light source luminance deterioration degree calculating unit 21 may calculate the luminance deterioration degrees of the respective light sources in relation to the entire backlight unit 100. Alternatively, when the light source for constructing the backlight unit 100 is divided into a plurality of light source blocks which can be controlled independently, the light source luminance deterioration degree calculating unit 21 may calculate the luminance deterioration degree of each of the light sources in relation to each of the light source blocks. The light source luminance deterioration degree judging unit 22 judges the light source in which the luminance deterioration degree is large, on the basis of the luminance deterioration degree of each of the light sources of the white light source 10, the red light source 11, the green light source 12, and the blue light source 13 calculated by the light source luminance deterioration degree calculating unit 21.

The light source driving method determining unit 23 determines the driving set values for each of the light sources of the white light source 10, the red light source 11, the green light source 12, and the blue light source 13, depending on the result of the judgment performed by the light source luminance deterioration degree judging unit 22. In this embodiment, it is assumed that LED of each of the light sources is driven in accordance with the PWM control. The current value allowed to flow to each of the light sources and the pulse width for the voltage modulation are determined as the driving set values. In the PWM control, the luminance of the light source is raised by increasing the current value allowed to flow to LED or increasing the pulse width.

The display setting control unit 24 accepts the designation of the target luminance and the target color temperature from a user, and the information is transmitted as the display setting information to the light source driving method determining unit 23.

The image signal processing unit 25 performs the signal processing for the image signal to be inputted into the display unit 101. For example, the image signal processing unit 25 calculates the color temperature and the luminance of the white light emitted by the backlight unit 100 on the basis of the driving set values for each of the light sources (for example, presence or absence of light emission for each light source, luminance, current value, and pulse width) determined by the light source driving method determining unit 23. If the calculated color temperature and the calculated luminance are not coincident with the target color temperature and the target luminance designated by the user, the image signal processing unit 25 performs the signal processing for the image signal so that the color temperature and the luminance of the transmitted light transmitted from the display unit 101 become the target color temperature and the target luminance.

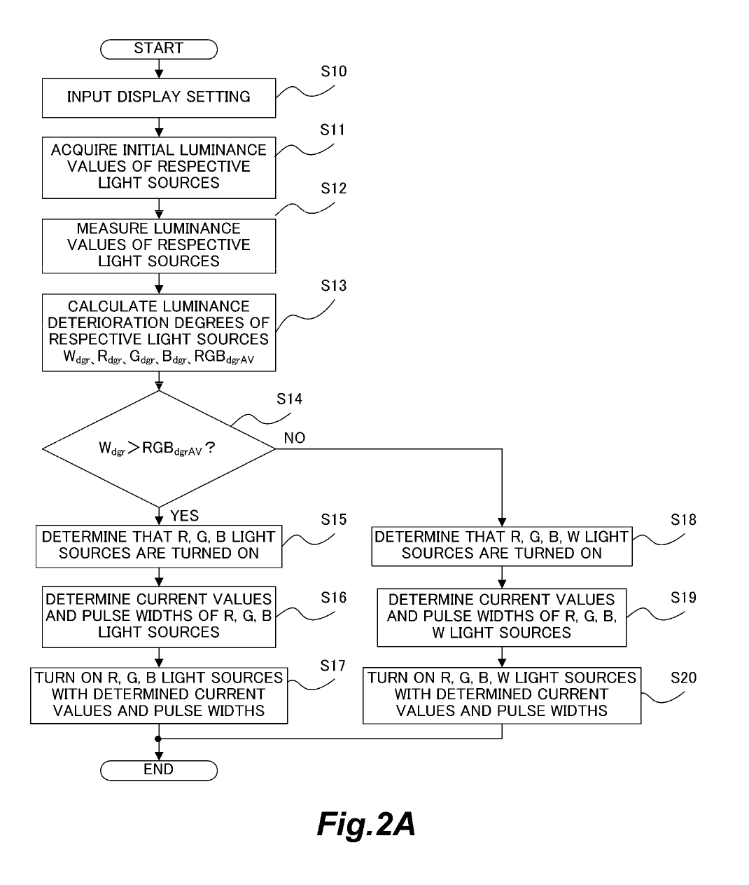

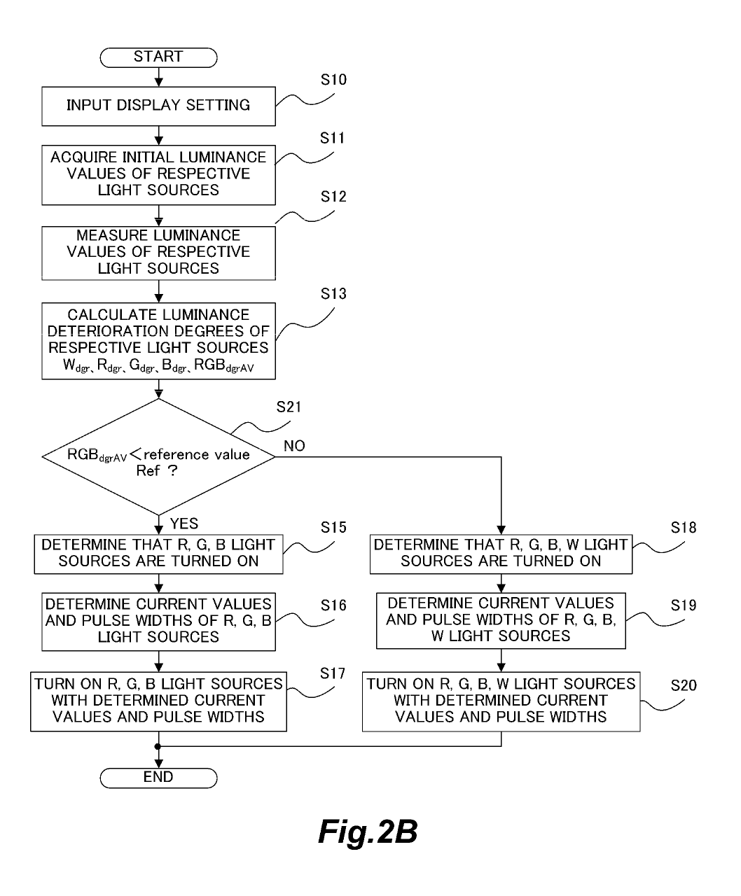

Next, an explanation will be made about the light source control for the backlight performed by the control unit 200 in the first embodiment. FIG. 2A shows a flowchart illustrating the light source control for the backlight.

At first, in S10, the display setting control unit 24 accepts the input of the display setting from the user. Specifically, the display setting control unit 24 accepts the input of the setting of the target values including, for example, the luminance, the color temperature, the color gamut, and the gamma value inputted by the user, and the information is transmitted as the display setting information to the light source driving method determining unit 23.

Subsequently, in S11, the initial luminance storage unit 20 transmits the stored information of the initial luminance to the light source luminance deterioration degree calculating unit 21.

Subsequently, in S12, the light source luminance detecting unit 15 measures the present luminance of each of the light sources by using the luminance detecting element. In this procedure, the driving condition of each of the light sources is set to the current value and the pulse width used when the initial luminance is measured. The information about the current value and the pulse width used when the initial luminance is measured is stored in the initial luminance storage unit 20 together with the information about the initial luminance. If the light source luminance detecting unit 15 is constructed so that the luminances of the light sources having the plurality of different wavelengths can be simultaneously detected, the light source luminance detecting unit 15 measures the luminances of the respective light sources by turning ON the respective light sources at once. If the light source luminance detecting unit 15 is constructed so that the luminance of the light source having the single wavelength can be detected, the light source luminance detecting unit 15 successively measures the luminance of each of the light sources by successively turning on the respective light sources.

Subsequently, in S13, the light source luminance deterioration degree calculating unit 21 calculates the luminance deterioration degree of each of the light sources from the initial luminance acquired from the initial luminance storage unit 20 in S11 and the present luminance measured by the light source luminance detecting unit 15 in S12. The light source luminance deterioration degree calculating unit 21 calculates the white light source luminance deterioration degree W_{dgr}, the red light source luminance deterioration degree R_{dgr}, the green light source luminance deterioration degree G_{dgr}, the blue light source luminance deterioration degree B_{dgr}, and the primary color light source average luminance deterioration degree RGB_{dgrAV}.

Subsequently, in S14, the light source luminance deterioration degree judging unit 22 compares the white light source luminance deterioration degree W_{dgr} calculated in S13 with the primary color light source average luminance deterioration degree RGB_{dgrAV} calculated in S13. As a result of the comparison, if the white light source luminance deterioration degree W_{dgr} is larger than the primary color light source average luminance deterioration degree RGB_{dgrAV}, the process proceeds to S15. In S15, the light source driving method determining unit 23 determines that the primary color light sources (red light source, green light source, and blue light source) are turned ON.

Subsequently, in S16, the light source driving method determining unit 23 determines the current values and the pulse widths of the red light source, the green light source, and the blue light source depending on the luminances of the red light source, the green light source, and the blue light source detected by the light source luminance detecting unit 15 and the target luminance and the target color temperature designated by the user. The relationship, which holds between the luminance and the color temperature observed when the light illuminated from the backlight unit 100 is transmitted through the liquid crystal panel and the current values and the pulse widths of the red light source, the green light source, and the blue light source, is previously stored as LUT or calculation expression in an unillustrated storage device.

The light source driving method determining unit 23 determines the current values and the pulse widths of the red light source, the green light source, and the blue light source by making reference to LUT stored in the storage device and performing the interpolation calculation, if necessary, depending on the luminance and the color temperature designated by the user. Alternatively, the light source driving method determining unit 23 calculates the current values and the pulse widths of the red light source, the green light source, and the blue light source by substituting the luminance and the color temperature designated by the user for the calculation expression stored in the storage device.

If the relationship, which is stored in the storage device, is prepared on condition that each of the light sources emits the light at the luminance which is a predetermined reference luminance (for example, the initial luminance), the light source driving method determining unit 23 may perform the correction corresponding to the difference between the present luminance of each of the light sources and the reference luminance. The correction may be performed by using the luminance deterioration degree calculated by the light source luminance deterioration degree calculating unit 21.

Subsequently, in S17, the light source driving unit 14 drives and turns ON the red light source, the green light source, and the blue light source with the current values and the pulse widths determined in S16.

On the other hand, as a result of the comparison in S14, if the white light source luminance deterioration degree W_{dgr} is not more than the primary color light source average luminance deterioration degree RGB_{dgrAV}, the process proceeds to S18. In S18, the light source driving method determining unit 23 determines that the red light source, the green light source, the blue light source, and the white light source are turned ON.

Subsequently, in S19, the light source driving method determining unit 23 determines the current values and the pulse widths of the respective light sources depending on the luminances of the red light source, the green light source, the blue light source, and the white light source detected by the light source luminance detecting unit 15 and the target luminance and the target color temperature designated by the user. The total value of the light amounts of the red light source, the green light source, and the blue light source determined in S16 is equal to the total value of the light amounts of the red light source, the green light source, the blue light source, and the white light source determined in S19.

Subsequently, in S20, the light source driving unit 14 drives and turns ON the red light source, the green light source, the blue light source, and the white light source with the current values and the pulse widths determined in S19. When the red light source, the green light source, the blue light source, and the white light source are turned ON, it is possible to realize the display color gamut which is wider than that obtained when only the red light source, the green light source, and the blue light source are turned ON. The reason, why the red light source, the green light source, the blue light source, and the white light source are turned ON without turning ON only the white light source in S18, is that the display color gamut is narrowed if only the white light source is turned ON. It is possible to realize the wide display color gamut by turning ON the red light source, the green light source, the blue light source, and the white light source. In this embodiment, it is premised that the deterioration speed of the white light source is faster than the deterioration speeds of the primary color light sources. Therefore, when the red light source, the green light source, the blue light source, and the white light source are continuously turned ON or lighted, the luminance deterioration degree of the white light source becomes larger than the primary color light source average luminance deterioration degree at a certain timing.

The processes of S12 to S20 may be executed periodically at time intervals designated by the user. Alternatively, the processes of S12 to S20 may be executed when the user instructs the execution of the calibration for the liquid crystal display apparatus 1. Further alternatively, the processes of S12 to S20 may be executed when the power source of the liquid crystal display apparatus 1 is turned OFF and/or when the power source is turned ON.

According to this embodiment, if the deterioration degree (average deterioration degree) of the primary color light source is smaller than the deterioration degree of the white light source, the primary color light source emits light. If the deterioration degree of the primary color light source is not less than the deterioration degree of the white light source, the primary color light source and the white light source emit light. Therefore, it is possible to suppress the occurrence of any dispersion between the luminance deterioration degree of the white light source and the luminance deterioration degree of each of the primary color light sources (red light source, green light source, and blue light source in this embodiment). Therefore, it is possible to maintain the performance of the backlight unit 100 for a long period of time.

If it is judged in S14 that the white light source luminance deterioration degree W_{dgr} is not more than the primary color light source average luminance deterioration degree RGB_{dgrAV}, it is assumed that the red light source, the green light source, the blue light source, and the white light source are turned ON. However, it is also appropriate to perform a different process depending on the difference between the white light source luminance deterioration degree W_{dgr} and the primary color light source average luminance deterioration degree RGB_{dgrAV}. Specifically, it is also appropriate to perform the following process. That is, if the difference between the white light source luminance deterioration degree W_{dgr} and the primary color light source average luminance deterioration degree RGB_{dgrAV} is not less than a threshold value (for example, if the primary color light source average luminance deterioration degree RGB_{dgrAV} is not less than twice the white light source luminance deterioration degree W_{dgr}), only the white light source is turned ON.

FIG. 2A is illustrative of such an exemplary case that the light source luminance deterioration degree judging unit 22 compares, in S14, the white light source luminance deterioration degree W_{dgr} calculated in S13 with the primary color light source average luminance deterioration degree RGB_{dgrAV} calculated in S13. However, the light source luminance deterioration degree may be judged as shown in FIG. 2B. Specifically, it is also appropriate to judge whether or not the primary color light source average luminance deterioration degree RGB_{dgrAV} is smaller than a predetermined reference value Ref in S21 shown in FIG. 2B. In this case, if the primary color light source average luminance deterioration degree RGB_{dgrAV} is smaller than the predetermined reference value Ref, then the process proceeds to S15, and the red light source, the green light source, and the blue light source are turned ON. On the other hand, if the primary color light source average luminance deterioration degree RGB_{dgrAV} is not less than the predetermined reference value Ref, then the process proceeds to S18, and the red light source, the green light source, the blue light source, and the white light source are turned ON.

### Second Embodiment

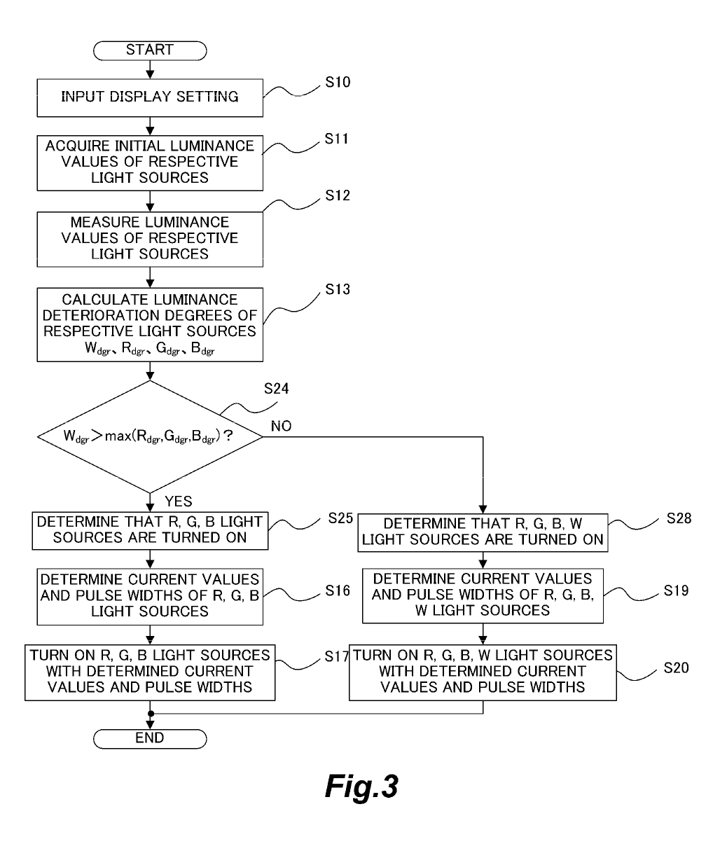

Next, a second embodiment of the present invention will be explained. A liquid crystal display apparatus 1 according to the second embodiment is constructed in the same manner as in the first embodiment. The difference between the second embodiment and the first embodiment resides in the control performed by a control unit 200. FIG. 3 shows a flow chart illustrating the flow of the control performed by the control unit 200 of the second embodiment. In FIG. 3, the steps, which indicate the same or equivalent contents as those of the control performed by the control unit 200 of the first embodiment, are designated by the same reference numerals as those of FIG. 2, any detailed explanation of which will be omitted. In the flow chart shown in FIG. 3, the judgment, which is performed by the light source luminance deterioration degree judging unit 22 in S24, is different from the judgment provided in S14 in the flow chart shown in FIG. 2 of the first embodiment. Specifically, in this embodiment, the light source luminance deterioration degree judging unit 22 compares, in S24, the luminance deterioration degree W_{dgr} of the white light source with the maximum value of the luminance deterioration degrees of the primary color light sources (red light source, green light source, and blue light source). Assuming that the red light source luminance deterioration degree is represented by R_{dgr}, the green light source luminance deterioration degree is represented by G_{dgr}, and the blue light source luminance deterioration degree is represented by B_{dgr}, the maximum value of them is represented by max (R_{dgr}, G_{dgr}, B_{dgr}).

As a result of the comparison in S24, if the luminance deterioration degree W_{dgr} of the white light source is larger than the maximum value max (R_{dgr}, G_{dgr}, B_{dgr}) of the luminance deterioration degrees of the primary color light sources, the process proceeds to S25. In S25, the light source driving method determining unit 23 determines that the red light source, the green light source, and the blue light source are turned ON. The following processes (S16, S17) are the same as or equivalent to those of the first embodiment.

On the other hand, as a result of the comparison in S24, if the maximum value max (R_{dgr}, G_{dgr}, B_{dgr}) of the luminance deterioration degrees of the primary color light sources is larger than the luminance deterioration degree W_{dgr} of the white light source, the process proceeds to S28. In S28, the light source driving method determining unit 23 determines that the red light source, the green light source, the blue light source, and the white light source are turned ON. The following processes (S19, S20) are the same as or equivalent to those of the first embodiment.

According to this embodiment, if the degree of deterioration of the primary color light source (maximum degree of deterioration) is smaller than the degree of deterioration of the white light source, the primary color light sources emit light. If the degree of deterioration of the primary color light source is not less than the degree of deterioration of the white light source, the primary color light sources and the white light source emit light. Therefore, it is possible to suppress the occurrence of any dispersion between the luminance deterioration degree of the white light source and the luminance deterioration degrees of the primary color light sources (red light source, green light source, and blue light source in this embodiment). Therefore, it is possible to maintain the performance of the backlight unit 100 for a long period of time. In particular, the light source control is performed such that the white light source is not turned ON or lighted if the luminance deterioration degree of the white light source is larger than the luminance deterioration degree of the light source which is included in the primary color light sources and which has the largest luminance deterioration degree. Therefore, it is possible to effectively suppress the dispersion of the luminance deterioration degree.

### Third Embodiment

Next, a third embodiment of the present invention will be explained. The difference in construction between the third embodiment and the first embodiment resides in that the backlight unit uses a yellow light source in the third embodiment in place of the white light source of the first embodiment. In particular, the light source unit of the first embodiment is constructed by the red light source, the green light source, the blue light source, and the white light source, while the light source unit of the third embodiment is constructed by the red light source, the green light source, the blue light source, and the yellow light source. The yellow light source is a light source which emits yellow-based light including, for example, yellow, yellow-green, and orange colors. A wider display color gamut can be realized when the red light source, the green light source, the blue light source, and the yellow light source are turned ON, as compared with when only the red light source, the green light source, and the blue light source are turned ON.

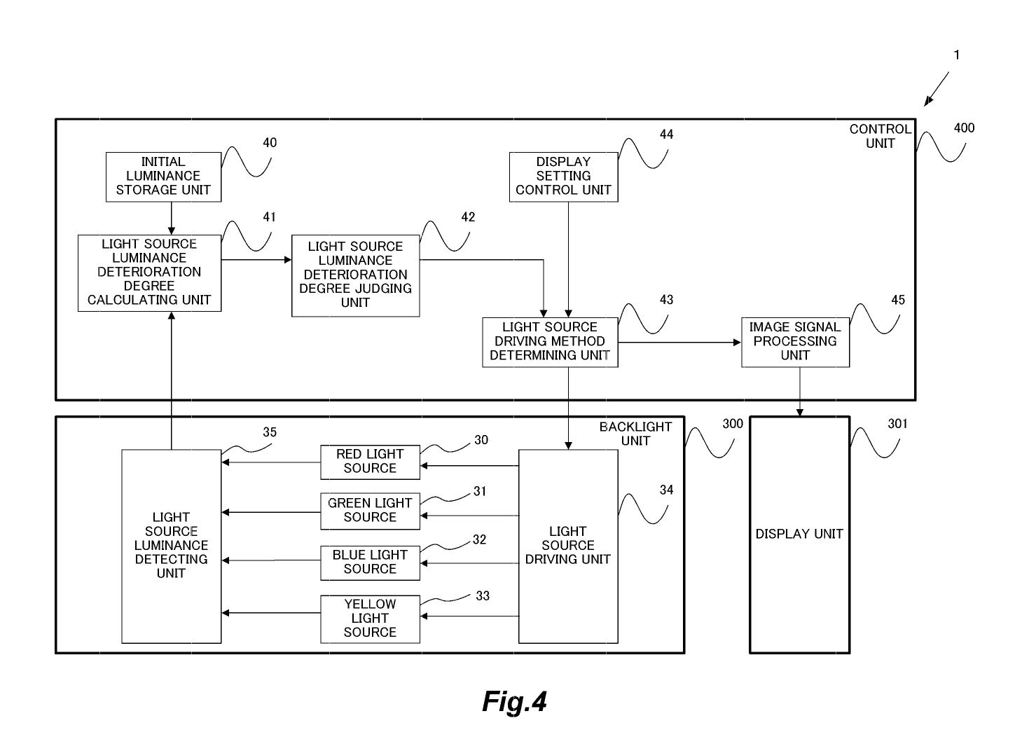

FIG. 4 shows an arrangement of a liquid crystal display apparatus 1 according to the third embodiment. The liquid crystal display apparatus 1 according to the third embodiment is composed of a backlight unit 300, a display unit 301, and a control unit 400.

The backlight unit 300 is composed of a red light source 30, a green light source 31, a blue light source 32, a yellow light source 33, a light source driving unit 34, and a light source luminance detecting unit 35. In this embodiment, the red light source 30, the green light source 31, and the blue light source 32 are collectively referred to as “primary color light source”. The primary color light source is the first light source (light source group) which generates the white light by means of the color mixture. The yellow light source 33 is the light source having the color different from those of the red light source 30, the green light source 31, and the blue light source 32 for constructing the first light source. The yellow light source 33 is the second light source which generates the white light by means of the color mixture with the first light source.

The numbers of the respective light sources of the red light source 30, the green light source 31, the blue light source 32, and the yellow light source 33 are determined depending on the luminance specification and the color gamut specification of the liquid crystal display apparatus 1. The numbers of the respective light sources maybe different from each other. The light source driving unit 34 is constructed by a current adjusting circuit and a voltage adjusting circuit for driving each of the light sources of the red light source 30, the green light source 31, the blue light source 32, and the yellow light source 33.

The light source luminance detecting unit 35 detects the luminances of the respective light sources of the red light source 30, the green light source 31, the blue light source 32, and the yellow light source 33. In the same manner as the light source luminance detecting unit 15 of the first embodiment, the light source luminance detecting unit 35 may be capable of simultaneously detecting the luminances of the light sources having a plurality of wavelengths. Alternatively, the light source luminance detecting unit 35 may be constructed to successively detect the luminances of the respective light sources by successively turning ON the respective light sources when the light source luminance detecting unit 35 is capable of detecting the luminance of the light source having a single wavelength.

The control unit 400 is constructed in the same manner as the control unit 200 of the first embodiment. However, the arrangement of the light source of the backlight unit 300 is different from that of the first embodiment. Therefore, the process contents of the respective functional units of the control unit 400 are different from the process contents of the respective functional units of the control unit 200 of the first embodiment.

For example, the initial luminance storage unit 40 stores, as the initial luminance, the luminance detected by the light source luminance detecting unit 35 when the respective light sources of the red light source 30, the green light source 31, the blue light source 32, and the yellow light source 33 are turned ON (lighted) with predetermined current values and pulse widths.

The light source luminance deterioration degree calculating unit 41 calculates the luminance deterioration degree of each of the light sources, on the basis of the luminance of each of the light sources detected by the light source luminance detecting unit 35 and the luminance of each of the light sources stored in the initial luminance storage unit 40. The red light source luminance deterioration degree R_{dgr}, the green light source luminance deterioration degree G_{dgr}, and the blue light source luminance deterioration degree B_{dgr} are calculated in accordance with the expressions explained in the first embodiment. The yellow light source luminance deterioration degree Y_{dgr} is calculated in accordance with the following expression.

Yellow light source luminance deterioration degree Y_{dgr}={(initial luminance of yellow light source)−(present luminance of yellow light source)}/(initial luminance of yellow light source)

The light source luminance deterioration degree judging unit 42 judges the light source in which the luminance deterioration degree is large, on the basis of the luminance deterioration degree of each of the light sources of the red light source 30, the green light source 31, the blue light source 32, and the yellow light source 33 calculated by the light source luminance deterioration degree calculating unit 41.

The light source driving method determining unit 43 determines the driving method for each of the light sources of the red light source 30, the green light source 31, the blue light source 32, and the yellow light source 33, depending on the result of the judgment performed by the light source luminance deterioration degree judging unit 42.

The image signal processing unit 45 performs the signal processing for the image signal to be inputted into the display unit 301. For example, the image signal processing unit 45 calculates the color temperature and the luminance of the white light generated by the red light source 30, the green light source 31, the blue light source 32, and the yellow light source 33 of the backlight unit 300, on the basis of the driving set values of each of the light sources (for example, presence or absence of light emission, luminance, current value, and pulse width). If the calculated color temperature and the calculated luminance are not coincident with the target color temperature and the target luminance designated by a user by means of the display setting control unit 44, the image signal processing unit 45 performs the signal processing for the image signal so that the color temperature and the luminance of the transmitted light from the display unit 301 become the target color temperature and the target luminance.

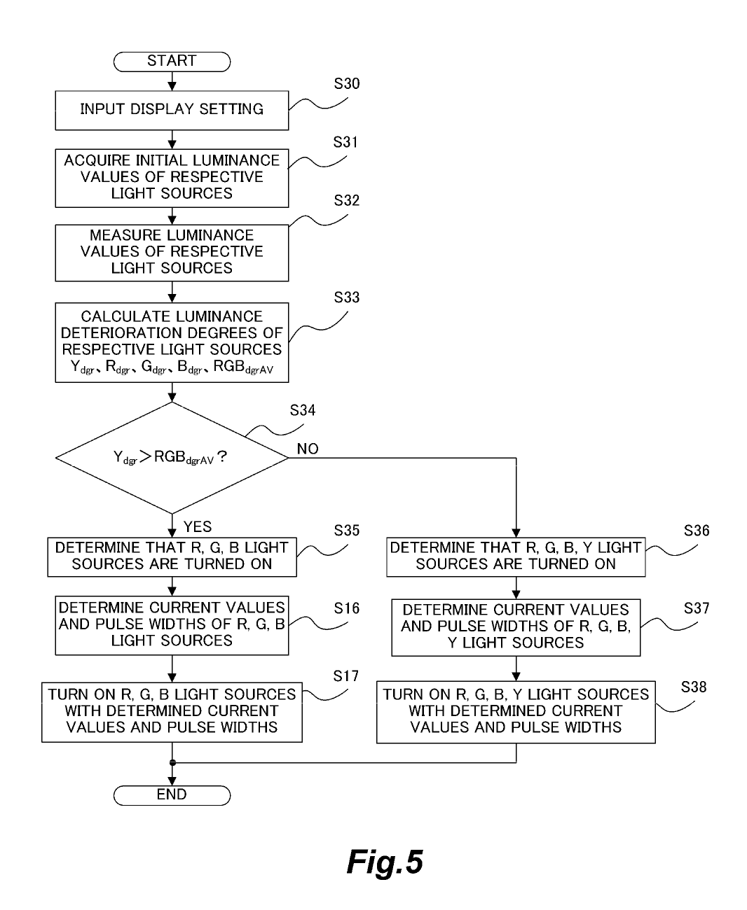

Next, an explanation will be made with reference to FIG. 5 about the backlight control performed by the control unit 400 in the third embodiment. The difference from the first embodiment principally resides in that the yellow light source luminance deterioration degree Y_{dgr} is calculated in place of the white light source luminance deterioration degree W_{dgr}, and the respective light sources are controlled on the basis of the comparison between the yellow light source luminance deterioration degree Y_{dgr} and the primary color light source average luminance deterioration degree RGB_{dgrAV} by the light source luminance deterioration degree judging unit 42.

In particular, in S31, the initial luminance storage unit 40 acquires the initial luminances of the red light source, the green light source, the blue light source, and the yellow light source.

In S32, the light source luminance detecting unit 35 measures the present luminances of the red light source, the green light source, the blue light source, and the yellow light source.

In S33, the light source luminance deterioration degree calculating unit 41 calculates the red light source luminance deterioration degree R_{dgr}, the green light source luminance deterioration degree G_{dgr}, the blue light source luminance deterioration degree B_{dgr}, the yellow light source luminance deterioration degree Y_{dgr}, and the primary color light source average luminance deterioration degree RGB_{dgrAV}.

In S34, the light source luminance deterioration degree judging unit 42 compares the yellow light source luminance deterioration degree Y_{dgr} with the primary color light source average luminance deterioration degree RGB_{dgrAV} As a result of the comparison, if the yellow light source luminance deterioration degree Y_{dgr} is larger than the primary color light source average luminance deterioration degree RGB_{dgrAV}, the process proceeds to S35. In S35, the light source driving method determining unit 43 determines that the primary color light sources (red light source, green light source, and blue light source in this embodiment) are turned ON. Subsequently, in S16 and S17, the current values and the pulse widths of the red light source, the green light source, and the blue light source are determined in the same manner as in the first embodiment. The red light source, the green light source, and the blue light source are driven with the determined current values and the pulse widths.

On the other hand, as a result of the comparison in S34, if the yellow light source luminance deterioration degree Y_{dgr} is not more than the primary color light source average luminance deterioration degree RGB_{dgrAV}, the process proceeds to S36. In S36, the light source driving method determining unit 43 determines that the primary color light sources (red light source, green light source, and blue light source in this embodiment) and the yellow light source are turned ON.

Subsequently, in S37, the light source driving method determining unit 43 determines the current values and the pulse widths of the red light source, the green light source, the blue light source, and the yellow light source depending on the luminances of the red light source, the green light source, the blue light source, and the yellow light source detected by the light source luminance detecting unit 35 and the target luminance and the target color temperature designated by the user.

Subsequently, in S38, the light source driving unit 34 drives and turns ON the red light source, the green light source, the blue light source, and the yellow light source with the current values and the pulse widths determined in S37. In this embodiment, it is premised that the deterioration speed of the yellow light source is faster than the deterioration speed of the primary color light source (red light source, green light source, and blue light source). Therefore, when the red light source, the green light source, the blue light source, and the yellow light source are continuously turned ON or lighted, the luminance deterioration degree of the yellow light source becomes larger than the primary color light source average luminance deterioration degree at a certain timing.

In S34, it is also appropriate that the light source luminance deterioration degree judging unit 42 compares the yellow light source luminance deterioration degree Y_{dgr} with the maximum value max (R_{dgr}, G_{dgr}, B_{dgr}) of the luminance deterioration degrees of the primary color light sources (red light source, green light source, and blue light source) in the same manner as in the second embodiment. In this case, if Y_{dgr}>max (R_{dgr}, G_{dgr}, B_{dgr}) is given, the light source driving method determining unit 43 determines, in S35, that the primary color light sources (red light source, green light source, and blue light source) are turned ON. If Y_{dgr}≦max (R_{dgr}, G_{dgr}, B_{dgr}) is given, the light source driving method determining unit 43 determines, in S36, that the primary color light sources (red light source, green light source, and blue light source) and the yellow light source are turned ON.

According to the third embodiment, if the deterioration degree of each of the primary color light sources (red light source, green light source, and blue light source) is smaller than the deterioration degree of the yellow light source, the primary color light source emits light. If the deterioration degree of each of the primary color light sources is not less than the deterioration degree of the yellow light source, the primary color light source and the yellow light source emit light. Therefore, it is possible to suppress the occurrence of any dispersion between the luminance deterioration degree of the yellow light source and the luminance deterioration degree of each of the primary color light sources in the illumination apparatus (backlight apparatus) in which the display color gamut is enlarged by using the yellow light source. Therefore, it is possible to maintain the wide color gamut performance for a long period of time.

### Fourth Embodiment

Next, a fourth embodiment of the present invention will be explained. The difference in construction between the fourth embodiment and the first embodiment resides in that a yellow light source is further added in relation to the backlight unit. In particular, the light source unit of the first embodiment is composed of the red light source, the green light source, the blue light source, and the white light source, while the light source unit of the fourth embodiment is composed of the red light source, the green light source, the blue light source, the white light source, and the yellow light source. The yellow light source is a light source which emits yellow-based light including, for example, yellow, yellow-green, and orange colors. A wider display color gamut can be realized when the red light source, the green light source, the blue light source, the white light source, and the yellow light source are turned ON, as compared with when only the red light source, the green light source, the blue light source, and the white light source are turned ON.

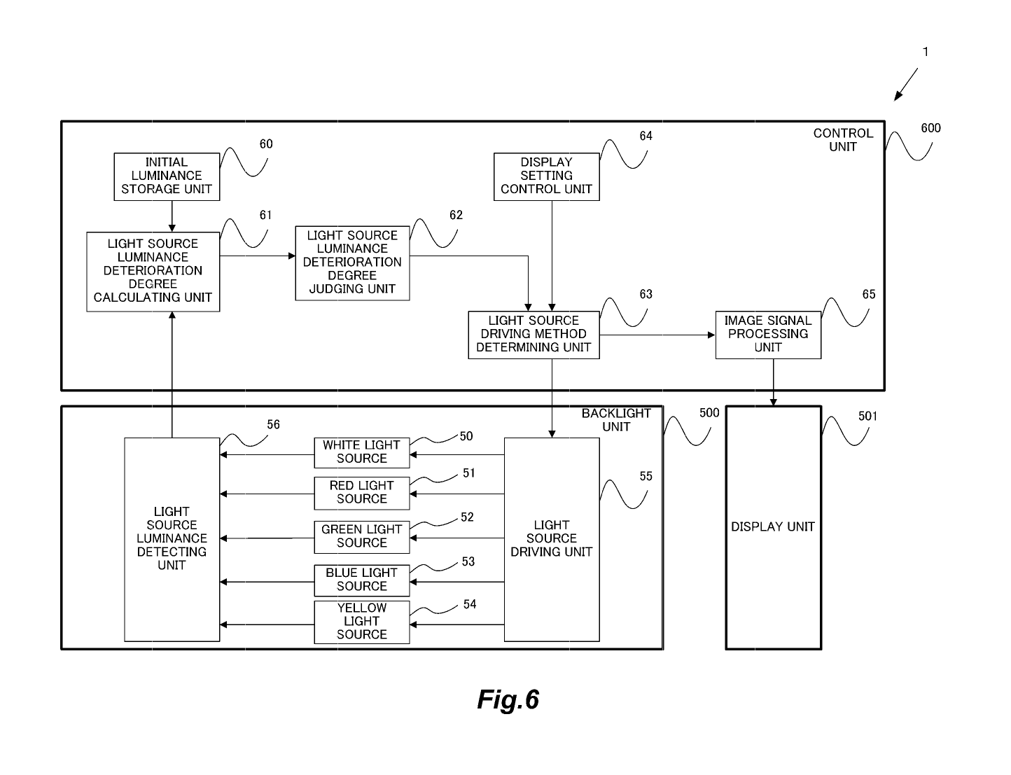

FIG. 6 shows an arrangement of a liquid crystal display apparatus 1 according to the fourth embodiment. The liquid crystal display apparatus 1 according to the fourth embodiment is composed of a backlight unit 500, a display unit 501, and a control unit 600.

The backlight unit 500 is composed of a white light source 50, a red light source 51, a green light source 52, a blue light source 53, a yellow light source 54, a light source driving unit 55, and a light source luminance detecting unit 56. In this embodiment, the red light source 51, the green light source 52, the blue light source 53, and the yellow light source 54 are collectively referred to as “colored light source”. The colored light source is the first light source (light source group) which generates the white light by means of the color mixture. The white light source 10 is the light source having the color different from those of the red light source 51, the green light source 52, the blue light source 53, and the yellow light source 54 for constructing the first light source. The white light source 10 is the second light source which generates the white light by means of the color mixture with the first light source.

The numbers of the white light source 50, the red light source 51, the green light source 52, the blue light source 53, and the yellow light source 54 are determined depending on the luminance specification and the color gamut specification of the liquid crystal display apparatus 1. The numbers of the respective light sources may be different from each other.

The light source driving unit 55 is constructed by a current adjusting circuit and a voltage adjusting circuit for driving each of the light sources of the white light source 50, the red light source 51, the green light source 52, the blue light source 53, and the yellow light source 54.

The light source luminance detecting unit 56 detects the luminances of the respective light sources of the white light source 50, the red light source 51, the green light source 52, the blue light source 53, and the yellow light source 54. In the same manner as the light source luminance detecting unit 15 of the first embodiment, the light source luminance detecting unit 56 may be constructed to be capable of simultaneously detecting the luminances of the light sources having a plurality of wavelengths. Alternatively, the light source luminance detecting unit 56 may be constructed to successively detect the luminances of the respective light sources while successively turning ON the respective light sources when the light source luminance detecting unit 56 is capable of detecting the luminance of the light source having a single wavelength.

The control unit 600 is constructed in the same manner as the control unit 200 of the first embodiment. However, the arrangement of the light source of the backlight unit 500 is different from that of the first embodiment. Therefore, the process contents of the respective functional units of the control unit 600 are different from the process contents of the respective functional units of the control unit 200 of the first embodiment.

For example, the initial luminance storage unit 60 stores, as the initial luminance, the luminance detected by the light source luminance detecting unit 56 when the respective light sources of the white light source 50, the red light source 51, the green light source 52, the blue light source 53, and the yellow light source 54 are turned ON (lighted) with predetermined current values and pulse widths.

The light source luminance deterioration degree calculating unit 61 calculates the luminance deterioration degree of each of the light sources, on the basis of the comparison between the luminance of each of the light sources detected by the light source luminance detecting unit 56 and the luminance of each of the light sources stored in the initial luminance storage unit 60. The white light source luminance deterioration degree W_{dgr}, the red light source luminance deterioration degree R_{dgr}, the green light source luminance deterioration degree G_{dgr}, and the blue light source luminance deterioration degree B_{dgr} are calculated in accordance with the expressions explained in the first embodiment. The yellow light source luminance deterioration degree Y_{dgr} is calculated in accordance with the expression explained in the third embodiment.

The light source luminance deterioration degree judging unit 62 judges the light source in which the luminance deterioration degree is large, on the basis of the luminance deterioration degree of each of the light sources of the white light source 50, the red light source 51, the green light source 52, the blue light source 53, and the yellow light source 54 calculated by the light source luminance deterioration degree calculating unit 61.

The light source driving method determining unit 63 determines the driving method for each of the light sources of the white light source 50, the red light source 51, the green light source 52, the blue light source 53, and the yellow light source 54, depending on the result of the judgment performed by the light source luminance deterioration degree judging unit 62.

The image signal processing unit 65 performs the signal processing for the image signal to be inputted into the display unit 501. For example, the image signal processing unit 65 calculates the color temperature and the luminance of the white light generated by the white light source 50, the red light source 51, the green light source 52, the blue light source 53, and the yellow light source 54 of the backlight unit 500, on the basis of the driving set values of each of the light sources. If the calculated color temperature and the calculated luminance are not coincident with the target color temperature and the target luminance designated by a user by means of the display setting control unit 64, the image signal processing unit 65 performs the signal processing for the image signal so that the color temperature and the luminance of the transmitted light from the display unit 501 become the target color temperature and the target luminance. The color temperature and the luminance of the white light emitted by the backlight unit 500 are determined on the basis of the driving set values of each of the light sources (for example, presence or absence of light emission, luminance, current value, and pulse width in relation to each light source).

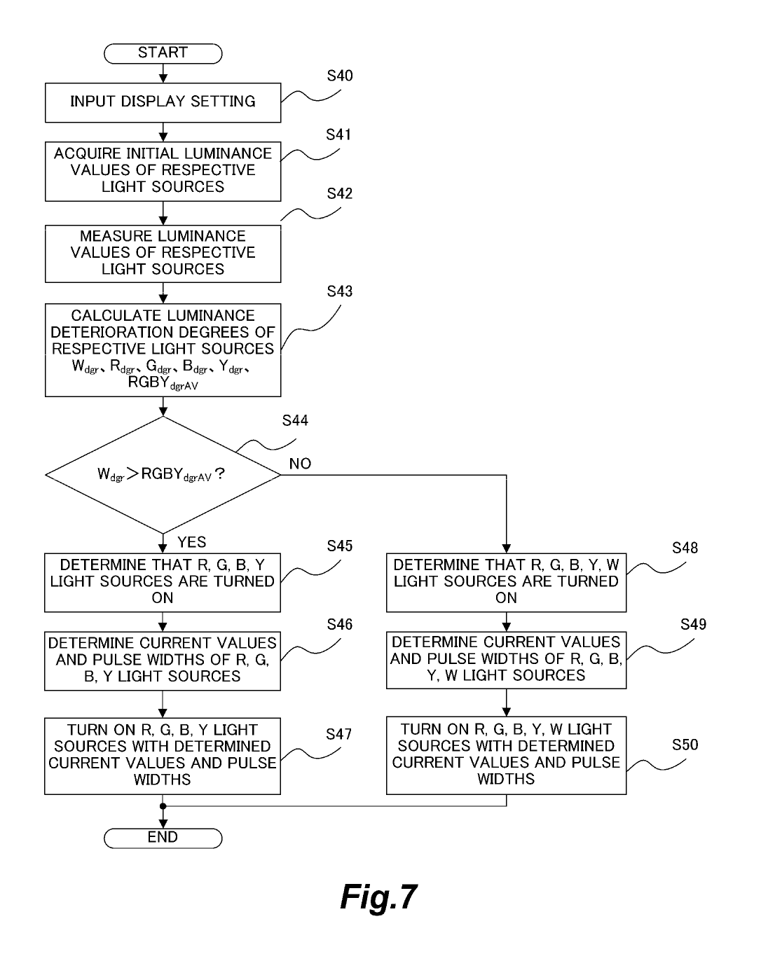

Next, an explanation will be made with reference to FIG. 7 about the backlight control performed by the control unit 600 in the fourth embodiment. The difference from the first embodiment principally resides in that the white light source luminance deterioration degree W_{dgr} and the colored light source average luminance deterioration degree RGBY_{dgrAV} are compared with each other. In this case, the colored light source average luminance deterioration degree RGBY_{dgrAV} is calculated in accordance with the following expression.

Colored light source average luminance deterioration degree RGBY_{dgrAV}=(R_{dgr}+G_{dgr}+B_{dgr}+Y_{dgr})/4

In S41, the initial luminance storage unit 60 acquires the initial luminances of the white light source, the red light source, the green light source, the blue light source, and the yellow light source.

In S42, the light source luminance detecting unit 56 measures the present luminances of the white light source, the red light source, the green light source, the blue light source, and the yellow light source.

In S43, the light source luminance deterioration degree calculating unit 61 calculates the white light source luminance deterioration degree W_{dgr}, the red light source luminance deterioration degree R_{dgr}, the green light source luminance deterioration degree G_{dgr}, the blue light source luminance deterioration degree B_{dgr}, the yellow light source luminance deterioration degree Y_{dgr}, and the colored light source average luminance deterioration degree RGBY_{dgrAV}.

In S44, the light source luminance deterioration degree judging unit 62 compares the white light source luminance deterioration degree W_{dgr} with the colored light source average luminance deterioration degree RGBY_{dgrAV}. As a result of the comparison, if the white light source luminance deterioration degree W_{dgr} is larger than the colored light source average luminance deterioration degree RGBY_{dgrAV} the process proceeds to S45. In S45, the light source driving method determining unit 63 determines that the colored light sources (red light source, green light source, blue light source, and yellow light source) are turned ON.

Subsequently, in S46, the light source driving method determining unit 63 determines the current values and the pulse widths of the red light source, the green light source, the blue light source, and the yellow light source depending on the luminances of the red light source, the green light source, the blue light source, and the yellow light source detected by the light source luminance detecting unit 56 and the target luminance and the target color temperature designated by the user.

Subsequently, in S47, the light source driving unit 55 drives and turns ON the red light source, the green light source, the blue light source, and the yellow light source with the current values and the pulse widths determined in S46.

On the other hand, as a result of the comparison in S44, if the white light source luminance deterioration degree W_{dgr} is not more than the colored light source average luminance deterioration degree RGBY_{dgrAV}, the process proceeds to S48. In S48, the light source driving method determining unit 63 determines that the white light source and the colored light sources (red light source, green light source, blue light source, and yellow light source) are turned ON.

Subsequently, in S49, the light source driving method determining unit 63 determines the current values and the pulse widths of the respective light sources depending on the luminances of the white light source, the red light source, the green light source, the blue light source, and the yellow light source detected by the light source luminance detecting unit 56 and the target luminance and the target color temperature designated by the user.

Subsequently, in S50, the light source driving unit 55 drives and turns ON the white light source, the red light source, the green light source, the blue light source, and the yellow light source with the current values and the pulse widths determined in S49.

In this embodiment, it is premised that the deterioration speed of the white light source is faster than the deterioration speed of each of the red light source, the green light source, the blue light source, and the yellow light source. Therefore, when the white light source, the red light source, the green light source, the blue light source, and the yellow light source are continuously turned ON or lighted, the luminance deterioration degree of the white light source becomes larger than the colored light source average luminance deterioration degree at a certain timing.

In S44, it is also appropriate that the light source luminance deterioration degree judging unit 62 compares the white light source luminance deterioration degree W_{dgr} with the maximum value max (R_{dgr}, G_{dgr}, B_{dgr}, Y_{dgr}) of the luminance deterioration degrees of the colored light sources (red light source, green light source, blue light source, and yellow light source in this embodiment). In this case, if W_{dgr}>max (R_{dgr}, G_{dgr}, B_{dgr}, Y_{dgr}) is given, the light source driving method determining unit 63 determines, in S45, that the colored light sources (red light source, green light source, blue light source, and yellow light source) are turned ON. If W_{dgr}≦max (R_{dgr}, G_{dgr}, B_{dgr}, Y_{dgr}) is given, the light source driving method determining unit 63 determines, in S48, that the white light source and the colored light sources (red light source, green light source, blue light source, and yellow light source) are turned ON.

According to the fourth embodiment, if the deterioration degree of each of the colored light sources (red light source, green light source, blue light source, and yellow light source) is smaller than the deterioration degree of the white light source, the colored light source emits light. If the deterioration degree of each of the colored light sources is not less than the deterioration degree of the white light source, the colored light source and the white light source emit light. Therefore, it is possible to suppress any dispersion between the luminance deterioration degree of the white light source and the luminance deterioration degree of each of the colored light sources in the illumination apparatus (backlight apparatus) in which both of the enlargement of the display color gamut and the light emission efficiency are fulfilled by using the red light source, the green light source, the blue light source, the yellow light source, and the white light source. Therefore, it is possible to maintain the wide color gamut performance and the high efficiency performance for a long period of time.

### Fifth Embodiment

Next, a fifth embodiment of the present invention will be explained. In this case, the primary color light sources are a red light source, a green light source, and a blue light source.

In the fifth embodiment, an explanation will be made about the backlight control performed when the primary color light source average luminance deterioration degree RGB_{dgrAV} is larger than the white light source luminance deterioration degree W_{dgr} by not less than a predetermined value in the arrangement explained in the first embodiment. Any difference, which is not less than the predetermined value, arises in some cases between the primary color light source average luminance deterioration degree RGB_{dgrAV} and the white light source luminance deterioration degree W_{dgr} depending on the environment of use for a user and the frequency of detection of the luminance deterioration degree. In other words, the difference arises when the deterioration of the white light source is caused extremely slowly as compared with the primary color light source. In such a situation, in this embodiment, the luminance of the white light source 10 is raised while maintaining the luminance of the white light emitted by the backlight unit 100 to be a target luminance. That is, the ratio of the white light source 10 is raised in relation to the luminance ratio between the white light source 10 and the primary color light source. Accordingly, it is possible to decrease the difference between the luminance deterioration degree of the primary color light source and the luminance deterioration degree of the white light source. A liquid crystal display apparatus 1 according to this embodiment is constructed in the same manner as the liquid crystal display apparatus 1 according to the first embodiment shown in FIG. 1.

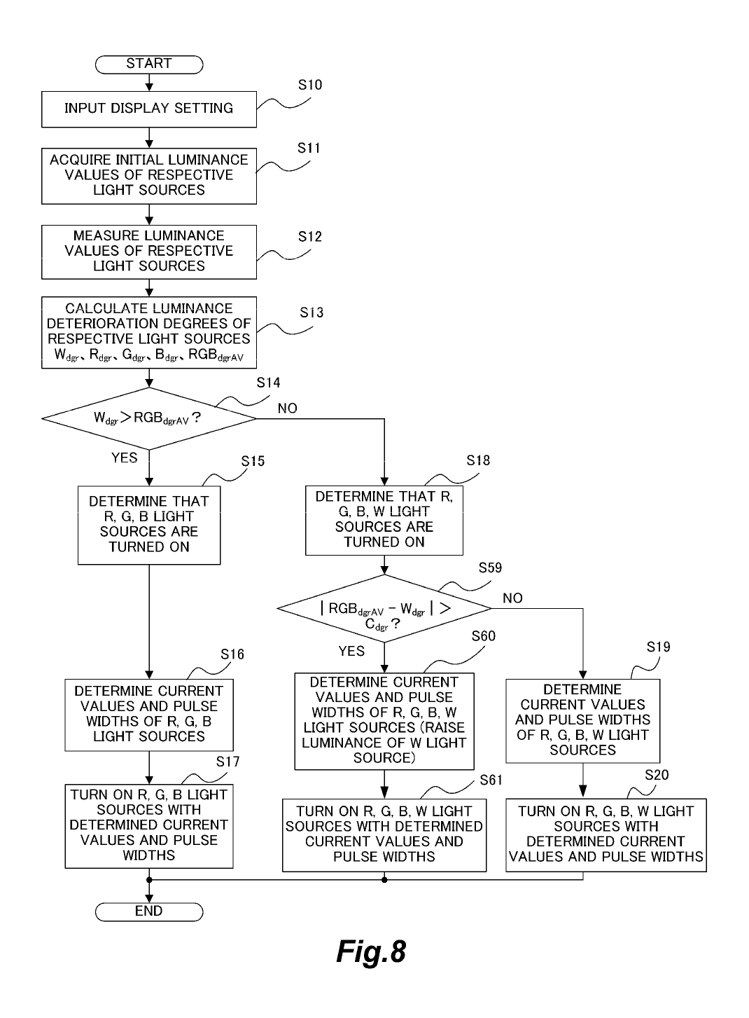

Next, an explanation will be made about a series of control operations performed by the control unit 200 in the fifth embodiment on the basis of FIGS. 1 and 8. In FIG. 8, the steps, in which the same processes as those shown in FIG. 2 explained in the first embodiment are performed, are designated by the same reference numerals as those shown in FIG. 2, any detailed explanation of which will be omitted.

This embodiment is different from the first embodiment in relation to the following features. That is, as a result of the comparison in S14, if the white light source luminance deterioration degree W_{dgr} is not more than the primary color light source average luminance deterioration degree RGB_{dgrAV} (S18), the process proceeds to S59. In S59, the light source luminance deterioration degree judging unit 22 calculates the absolute value of the difference between the white light source luminance deterioration degree W_{dgr} and the primary color light source average luminance deterioration degree RGB_{dgrAV}, and the calculated absolute value of the difference is compared with a predetermined value C_{dgr}. If the absolute value of the difference is larger than the predetermined value C_{dgr}, then the process proceeds to S60, and the light source driving method determining unit 23 raises the luminance of the white light source as compared with if the absolute value of the difference is not more than the predetermined value. For example, it is assumed in S60 that the ratio between the light amount of the white light source and the light amount of the primary color light source (total value of light amounts of red light source, green light source, and blue light source) is 1:1, and it is assumed in S19 that the ratio between the light amount of the white light source and the light amount of the primary color light source is 1:2.

That is, the light source driving method determining unit 23 determines the current values and the pulse widths of the red light source, the green light source, the blue light source, and the white light source so that the ratio (contribution) of the white light source is increased in the luminance of the light emitted by the backlight unit 100. The light source driving method determining unit 23 may increase the magnitude of the luminance ratio of the white light source by a predetermined ratio. Alternatively, the light source driving method determining unit 23 may determine the same depending on the degree of deviation from the predetermined value C_{dgr}, of the absolute value of the difference between the white light source luminance deterioration degree W_{dgr} and the primary color light source average luminance deterioration degree RGB_{dgrAV}. For example, the light source driving method determining unit 23 may determine the luminance ratio of the white light source so that the larger the difference between the absolute value of the difference and the predetermined value C_{dgr} is, the higher the luminance ratio of the white light source is.

Subsequently, in S61, the light source driving unit 14 drives and turns ON the red light source, the green light source, the blue light source, and the white light source with the current values and the pulse widths determined in S60. According to this embodiment, even when the luminance deterioration degree of the white light source is changed extremely slowly as compared with the luminance deterioration degree of the primary color light source (red light source, green light source, and blue light source in this case), it is possible to reduce any deviation in the luminance deterioration degree between the both in a short period of time. Therefore, it is possible to maintain the performance of the backlight 100 for a long period of time.

The concept of this embodiment can be also applied to the second to fourth embodiments. When the concept is applied to the second embodiment, in S24 shown in FIG. 3, the light source luminance deterioration degree judging unit 22 compares the absolute value of the difference |max (R_{dgr}, G_{dgr}, B_{dgr})−W_{dgr}| with a predetermined value if W_{dgr}≦max (R_{dgr}, G_{dgr}, B_{dgr}) is given. If the absolute value of the difference is larger than the predetermined value, the light source driving method determining unit 23 controls the lighting of each of the light sources so that the luminance ratio of the white light source is raised.

When the concept is applied to the third embodiment, in S34 shown in FIG. 5, the light source luminance deterioration degree judging unit 42 compares the absolute value of the difference |RGB_{dgrAV}−Y_{dgr}| with a predetermined value if Y_{dgr}≦RGB_{dgrAV} is given. If the absolute value of the difference is larger than the predetermined value, the light source driving method determining unit 43 controls the lighting of each of the light sources so that the luminance ratio of the yellow light source is raised. Accordingly, even when the luminance deterioration degree of the yellow light source is changed extremely slowly as compared with the luminance deterioration degree of the primary color light source (red light source, green light source, and blue light source in this case), it is possible to reduce any dispersion in the luminance deterioration degree between the primary color light source and the yellow light source in a short period of time.

When the concept is applied to the fourth embodiment, in S44 shown in FIG. 7, the light source luminance deterioration degree judging unit 62 compares the absolute value of the difference |RGBY_{dgrAV}−W_{dgr}| with a predetermined value if W_{dgr}≦RGBY_{dgrAV} is given. If the absolute value of the difference is larger than the predetermined value, the light source driving method determining unit 63 controls the lighting of each of the light sources so that the luminance ratio of the white light source is raised. Accordingly, even when the luminance deterioration degree of the white light source is changed extremely slowly as compared with the luminance deterioration degree of the colored light source (red light source, green light source, blue light source, and yellow light source in this case), it is possible to reduce any dispersion in the luminance deterioration degree between the colored light source and the white light source in a short period of time.

### Sixth Embodiment

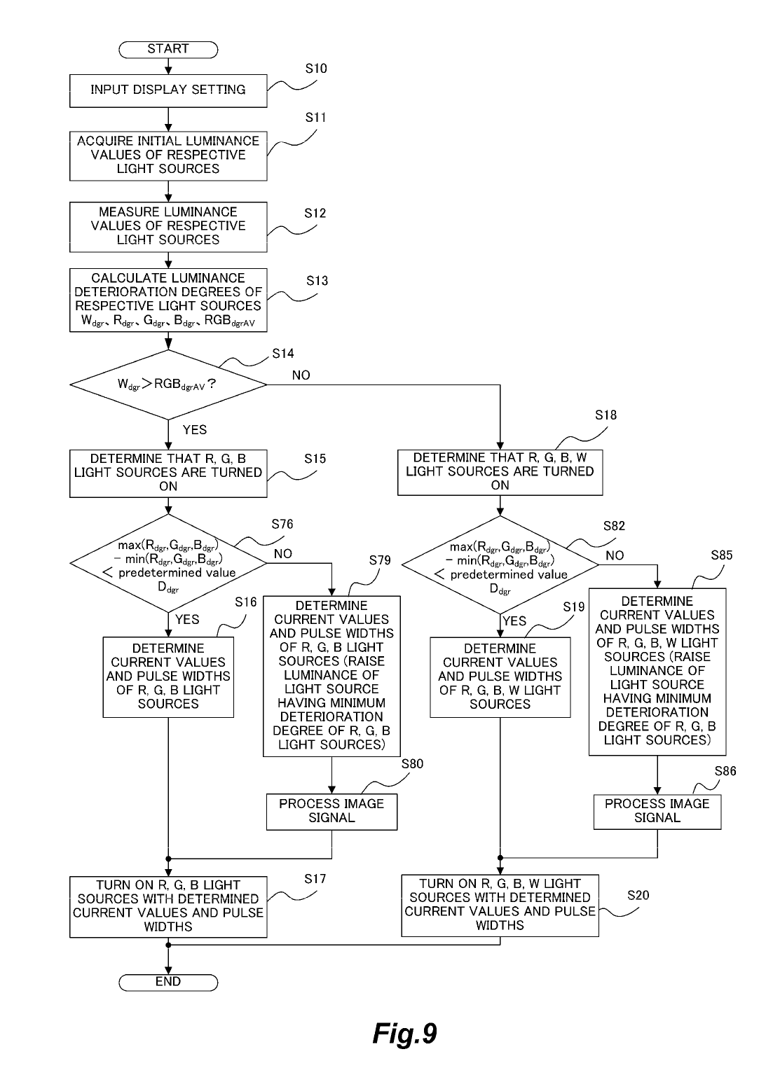

Next, a sixth embodiment of the present invention will be explained. In the sixth embodiment, the control is performed on the basis of the difference between the maximum value max (R_{dgr}, G_{dgr}, B_{dgr}) and the minimum value min (R_{dgr}, G_{dgr}, B_{dgr}) of the luminance deterioration degrees of the primary color light sources in the arrangement explained in the first embodiment. An explanation will be made about the backlight control performed by the control unit 200 in the sixth embodiment on the basis of FIG. 9. In FIG. 9, the steps, in which the same processes as those shown in FIG. 2 explained in the first embodiment are performed, are designated by the same reference numerals as those shown in FIG. 2, any detailed explanation of which will be omitted.

In this embodiment, the process proceeds to S76 after the light source driving method determining unit 23 determines, in S15, that the primary color light sources (red light source, green light source, and blue light source in this case) are turned ON. In S76, the light source luminance deterioration degree judging unit 22 calculates the difference between max (R_{dgr}, G_{dgr}, B_{dgr}) and min (R_{dgr}, G_{dgr}, B_{dgr}), and the calculated difference is compared with a predetermined value D_{dgr}. If the difference is not less than the predetermined value D_{dgr}, the light source driving method determining unit 23 raises, in S79, the luminance of the light source which is included in the primary color light sources and which has the smallest luminance deterioration degree, as compared with if the difference is smaller than the predetermined value.

That is, the light source driving method determining unit 23 performs the correction such that the current value and the pulse width of the concerning light source are increased as compared with the current value and the pulse width provided in an ordinary case as determined depending on the luminance and the color temperature designated by a user (case in which the difference is smaller than the predetermined value D_{dgr}). Accordingly, it is possible to reduce any dispersion of the luminance deterioration degree of the primary color light source. The light source driving method determining unit 23 may determine the correction amounts for the current value and the pulse width of the light source having the minimum luminance deterioration degree in accordance with a predetermined amount or ratio. Alternatively, the light source driving method determining unit 23 may determine the correction amounts in accordance with the degree of deviation of the difference from the predetermined value D_{dgr}.

For example, the light source driving method determining unit 23 may more increase the correction amounts as the degree of deviation of the difference from the predetermined value D_{dgr} is larger. When the luminance of the light source having the small luminance deterioration degree is raised, there is such a possibility that the luminance and the color temperature of the transmitted light of the illumination light emitted by the backlight unit 100 and allowed to come from the display unit 101 are not coincident with the luminance and the color temperature designated by the user. If the luminance and the color temperature are not coincident, the image signal processing unit 25 applies, in S80, the image processing to the image signal to be inputted into the display unit 101 so that the luminance and the color temperature of the transmitted light allowed to come from the display unit 101 are coincident with the target luminance and the target color temperature designated by the user. Accordingly, even when the light source driving is performed to suppress the dispersion of the luminance deterioration degree of the primary color light source as described above, it is possible to realize the luminance and the color temperature designated by the user.

Similarly, the process proceeds to S82 after the light source driving method determining unit 23 determines, in S18, that the primary color light sources (red light source, green light source, and blue light source) and the white light source are turned ON. In S82, the light source luminance deterioration degree judging unit 22 calculates the difference between max (R_{dgr}, G_{dgr}, B_{dgr}) and min (R_{dgr}, G_{dgr}, B_{dgr}), and the calculated difference is compared with the predetermined value D_{dgr}. If the difference is not less than the predetermined value D_{dgr}, the light source driving method determining unit 23 raises, in S85, the luminance of the light source which is included in the primary color light sources and which has the smallest luminance deterioration degree.

That is, the light source driving method determining unit 23 performs the correction such that the current value and the pulse width of the concerning light source are increased as compared with the current value and the pulse width provided in an ordinary case as determined depending on the luminance and the color temperature designated by the user (case in which the difference is smaller than the predetermined value D_{dgr}). In accordance with this correction, the image signal processing unit 25 applies, in S86, the correcting process to the image signal to be inputted into the display unit 101 so that the luminance and the color temperature of the transmitted light allowed to come from the display unit 101 are coincident with the target luminance and the target color temperature designated by the user.

According to the control of the sixth embodiment, the dispersion of the luminance deterioration degree of the primary color light source (red light source, green light source, and blue light source in this case) can be reduced in a short period of time. Therefore, it is possible to maintain the performance of the backlight unit 100 for a long period of time.

The concept of this embodiment can be also applied to the second to fourth embodiments. When the concept is applied to the second embodiment, the light source luminance deterioration degree judging unit 22 performs the judgment of S76 described above in the step next to the determination of the lighting of the primary color light source (red light source, green light source, and blue light source) by the light source driving method determining unit 23 in S25 shown in FIG. 3. If the difference is not less than the predetermined value, the processes of S79 to S80 are performed. Further, the light source luminance deterioration degree judging unit 22 performs the judgment of S82 described above in the step next to the determination of the lighting of the primary color light source (red light source, green light source, and blue light source) and the white light source by the light source driving method determining unit 23 in S28. If the difference is not less than the predetermined value, the processes of S85 to S86 are performed.

When the concept is applied to the third embodiment, the light source luminance deterioration degree judging unit 42 performs the judgment of S76 described above in the step next to the determination of the lighting of the primary color light source (red light source, green light source, and blue light source) by the light source driving method determining unit 43 in S35 shown in FIG. 5. If the difference is not less than the predetermined value, the processes of S79 to S80 are performed. Further, the light source luminance deterioration degree judging unit 42 performs the judgment of S82 described above in the step next to the determination of the lighting of the primary color light source (red light source, green light source, and blue light source) and the yellow light source by the light source driving method determining unit 43 in S36.

If the difference is not less than the predetermined value, the light source driving method determining unit 43 performs the correction to raise the luminance of the light source which has the smallest luminance deterioration degree and which is included in the primary color light source (red light source, green light source, and blue light source). In accordance with this correction, the image signal processing unit 45 applies the correcting process to the image signal to be inputted into the display unit so that the luminance and the color temperature of the transmitted light of the illumination light emitted by the backlight unit and allowed to come from the display unit are coincident with the luminance and the color temperature designated by the user. Accordingly, the dispersion of the luminance deterioration degree of the primary color light source (red light source, green light source, and blue light source in this case) can be reduced in a short period of time. It is possible to maintain the performance of the multi-primary color light source backlight for a long period of time.

When the concept is applied to the fourth embodiment, the light source luminance deterioration degree judging unit 62 calculates the difference between max (R_{dgr}, G_{dgr}, B_{dgr}, Y_{dgr}) and min (R_{dgr}, G_{dgr}, B_{dgr}, Y_{dgr}) after the light source driving method determining unit 63 determines that the colored light source is turned ON in S45 shown in FIG. 7. The calculated difference and the predetermined value are compared with each other. If the difference is not less than the predetermined value, the light source driving method determining unit 63 performs the correction so that the current value and the pulse width are increased for the light source which has the smallest luminance deterioration degree and which is included in the colored light source (red light source, green light source, blue light source, and yellow light source).

In accordance with this correction, the image signal processing unit 65 applies the correcting process to the image signal to be inputted into the display unit so that the luminance and the color temperature of the transmitted light of the illumination light emitted by the backlight unit and allowed to come from the display unit are coincident with the luminance and the color temperature designated by the user.

Further, the light source luminance deterioration degree judging unit 62 calculates the difference between max (R_{dgr}, G_{dgr}, B_{dgr}, Y_{dgr}) and min (R_{dgr}, G_{dgr}, B_{dgr}, Y_{dgr}) after the light source driving method determining unit 63 determines that the colored light source and the white light source are turned ON in S48. The calculated difference and the predetermined value are compared with each other. If the difference is not less than the predetermined value, the light source driving method determining unit 63 performs the correction so that the current value and the pulse width are increased for the light source which has the smallest luminance deterioration degree and which is included in the colored light source (red light source, green light source, blue light source, and yellow light source).

In accordance with this correction, the image signal processing unit 65 applies the correcting process to the image signal to be inputted into the display unit so that the luminance and the color temperature of the transmitted light of the illumination light emitted by the backlight unit and allowed to come from the display unit are coincident with the luminance and the color temperature designated by the user. Accordingly, the dispersion of the luminance deterioration degree of the colored light source (red light source, green light source, blue light source, and yellow light source in this case) can be reduced in a short period of time. It is possible to maintain the performance of the multi-primary color light source backlight for a long period of time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-130410, filed on Jun. 10, 2011, and Japanese Patent Application No. 2012-071494, filed on Mar. 27, 2012, which are hereby incorporated by reference herein in their entirety.

What is claimed is:

1. An illumination apparatus comprising:
a light source unit having a first light source which is composed of a plurality of light-emitting elements for generating white light by means of color mixture and a second light source which is composed of a light-emitting element having a color different from those of the plurality of light-emitting elements for constructing the first light source and which generates white light by means of color mixture with the first light source;
a judging unit which judges degrees of deterioration of the first light source and the second light source; and
a control unit which allows the first light source to emit light if the degree of deterioration of the first light source is smaller than the degree of deterioration of the second light source and which allows the first light source and the second light source to emit light if the degree of deterioration of the first light source is not less than the degree of deterioration of the second light source.

2. The illumination apparatus according to claim 1, wherein the control unit raises a luminance of the second light source if the degree of deterioration of the first light source is not less than the degree of deterioration of the second light source and a difference between the degree of deterioration of the first light source and the degree of deterioration of the second light source is larger than a predetermined value, as compared with if the difference is not more than the predetermined value.

3. The illumination apparatus according to claim 1, wherein the control unit raises a luminance of the light source having the minimum degree of deterioration of those of the plurality of light sources for constructing the first light source if a difference between a maximum value and a minimum value of the degrees of deterioration of the respective light sources for constructing the first light source is larger than a predetermined value, as compared with if the difference is not more than the predetermined value.

4. The illumination apparatus according to claim 1, further comprising:
a detecting unit which detects luminances of the respective light sources; and
a calculating unit which calculates the degrees of deterioration of the first light source and the second light source on the basis of the luminances detected by the detecting unit.

5. The illumination apparatus according to claim 1, wherein the first light source is composed of a plurality of light sources including a red light source, a green light source, and a blue light source.

6. The illumination apparatus according to claim 1, wherein the second light source is a white light source.

7. The illumination apparatus according to claim 1, wherein the second light source is a yellow light source.

8. The illumination apparatus according to claim 5, wherein:
the first light source further includes a yellow light source; and
the second light source is a white light source.

9. The illumination apparatus according to claim 1, further comprising:
a detecting unit which detects luminances of the respective light sources; and
a calculating unit which calculates the degrees of deterioration of the first light source and the second light source on the basis of the luminances detected by the detecting unit, wherein:
the first light source is composed of a plurality of light sources including a red light source, a green light source, and a blue light source; and
the calculating unit calculates an average value or a maximum value of the degree of deterioration of the red light source, the degree of deterioration of the green light source, and the degree of deterioration of the blue light source as the degree of deterioration of the first light source.

10. The illumination apparatus according to claim 1, further comprising:
a detecting unit which detects luminances of the respective light sources; and
a calculating unit which calculates the degrees of deterioration of the first light source and the second light source on the basis of the luminances detected by the detecting unit, wherein:
the first light source includes a red light source, a green light source, a blue light source, and a yellow light source;
the second light source is a white light source; and
the calculating unit calculates an average value or a maximum value of the degree of deterioration of the red light source, the degree of deterioration of the green light source, the degree of deterioration of the blue light source, and the degree of deterioration of the yellow light source as the degree of deterioration of the first light source.

11. A liquid crystal display apparatus comprising:
the illumination apparatus as defined in claim 1;
a liquid crystal panel which displays an image on the basis of an image signal by transmitting light illuminated by the illumination apparatus at a transmittance corresponding to the image signal; and
an image processing unit which performs signal processing for the image signal to be inputted into the liquid crystal panel so that a luminance and a color temperature of the light transmitted through the liquid crystal panel are a predetermined target luminance and a target color temperature on the basis of luminances and presence or absence of light emission of the first light source and the second light source controlled by the control unit.

12. A method for controlling an illumination apparatus comprising a first light source which is composed of a plurality of light-emitting elements for generating white light by means of color mixture and a second light source which is composed of a light-emitting element having a color different from those of the plurality of light-emitting elements for constructing the first light source and which generates white light by means of color mixture with the first light source, the method comprising:
a judging step of judging degrees of deterioration of the first light source and the second light source, and a control step of allowing the first light source to emit light if the degree of deterioration of the first light source is smaller than the degree of deterioration of the second light source and allowing the first light source and the second light source to emit light if the degree of deterioration of the first light source is not less than the degree of deterioration of the second light source.
